(19) United States
(12) Patent Application Publication
(10) Pub. No.: US 2014/0010269 A1
(43) Pub. Date: Jan. 9, 2014

(54) METHOD AND SYSTEM FOR DETECTING AND MITIGATING INTERFERENCE IN A CABLE NETWORK SYSTEM

(71) Applicants: Curtis Ling, Carlsbad, CA (US); Tim Gallagher, Encinitas, CA (US); Sridhar Ramesh, Carlsbad, CA (US)

(72) Inventors: Curtis Ling, Carlsbad, CA (US); Tim Gallagher, Encinitas, CA (US); Sridhar Ramesh, Carlsbad, CA (US)

(21) Appl. No.: 13/937,143

(22) Filed: Jul. 8, 2013

Related U.S. Application Data
(60) Provisional application No. 61/668,825, filed on Jul. 6, 2012.

(51) Int. Cl. H04L 1/20

(52) U.S. Cl. CPC H04L 1/20
USPC 375/222

(57) ABSTRACT

A cable modem (CM) device captures signals over a wide spectrum including one or more cable frequency bands and sub-bands, and extracts one or more cable channels from the captured signals. The CM device is operable to analyze the extracted one or more cable channels and assigns a portion of the extracted one or more cable channels for upstream and/or downstream communication based on the analysis. The CM device may recapture one or more previously unused cable channels to be utilized for the upstream and/or downstream communication based on the analysis. The CM device may determine noise, interference and/or blocker information corresponding to the extracted one or more cable channels based on the analysis. Based on the determined noise, interference and/or blocker information, the cable modem termination system (CMTS) may assign or block usage of one or more cable channels for the upstream and/or downstream communication.

### CROSS-REFERENCE TO RELATED APPLICATIONS/INCORPORATION BY REFERENCE

This patent application makes reference to, claims priority to and claims benefit from the U.S. Provisional Patent Application Ser. No. 61/668,825, filed on Jul. 6, 2012.

This application also makes reference to:
U.S. application Ser. No. 13/485,003 filed May 31, 2012;
U.S. application Ser. No. 13/336,451 filed on Dec. 23, 2011;
U.S. application Ser. No. ______ (Attorney Docket No. 25616US02) filed on even date herewith; and
U.S. Pat. No. 8,010,070, (application Ser. No. 12/247,908), which issued on Aug. 30, 2011, discloses exemplary Low-Complexity Diversity Using Coarse FFT and Coarse Sub-band-wise Combining.

Each of the above stated applications is hereby incorporated herein by reference in its entirety.

### FIELD OF THE INVENTION

Certain embodiments of the invention relate to wired communication. More specifically, certain embodiments of the invention relate to a method and system for detecting and mitigating interference in a cable network system.

### BACKGROUND OF THE INVENTION

DOCSIS is widely used as a communication protocol between the customer side (premises) cable modem (CM) and network side cable modem termination system (CMTS) equipment in cable broadband as well as digital video applications. Modern DOCSIS devices are capable of transferring data at very high speeds by bonding channels at several frequencies in both upstream (from CM to CMTS) and downstream (CMTS to CM) directions. Consequently, the power consumption and processing capabilities are very high. However, the requirement for very high throughput exists only when user applications are active. There may be large periods of time when the user applications are inactive when the throughput requirement is low.

Existing schemes for saving power may include significant handshaking between the CMTS and the CM. For example, cable modems with battery backup, which are referred to as embedded multimedia terminal adapters or eMTAs, are operable to scale back from a multiple-channel bonded mode to a single channel (1×1) mode in the event of a power failure. However, the process involves handshaking, which includes issuing a dynamic bonding change (DBC) request to the CMTS and obtaining a DBC response from the CMTS authorizing the CM to enter a 1×1 mode. When the cable needs to return to full scale operation following a power restoration, it issues another DBC request to the CMTS and waits for a DBC response before resuming normal operation.

The use of such handshaking may result in various issues such as lack of scalability and increased latency. Handshaking places extra burden on a CMTS that services more cable modems and it also adds more latency for a cable modem entering and exiting lower power consumption modes. Furthermore, as cable modem devices repeatedly and frequently enter and exit these low power modes in response to diurnal variations in data and content utilization or consumption by users, a requirement is imposed on the CMTS to track the state of each associated cable mode.

Further limitations and disadvantages of conventional and traditional approaches will become apparent to one of skill in the art, through comparison of such systems with some aspects of the present invention as set forth in the remainder of the present application with reference to the drawings

### BRIEF SUMMARY OF THE INVENTION

A system and/or method is provided for detecting and mitigating interference in a cable network system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary cable network system, in accordance with an exemplary embodiment of the invention.

FIG. 2A is a block diagram that illustrates an exemplary cable modem termination system that utilizes a plurality of burst receivers and port switching in the cable headend, in accordance with an exemplary embodiment of the invention.

FIG. 2B is a block diagram that illustrates an exemplary multiband communication system that supports multiplexing various communication streams, in accordance with an exemplary embodiment of the invention.

FIG. 2C is a block diagram that illustrates an exemplary cable modem transceiver device comprising a full spectrum capture receiver, in accordance with an exemplary embodiment of the invention.

FIG. 3A is a high level block diagram illustrating cable modem assisted monitoring, in accordance with an exemplary embodiment of the invention.

FIG. 3B is a high level block diagram illustrating amplifier assisted monitoring, in accordance with an exemplary embodiment of the invention.

FIG. 4 is a diagram that illustrates the mapping of essential messages onto the primary channel, in accordance with an exemplary embodiment of the invention.

FIG. 5 is a flow chart illustrating exemplary steps for detecting and mitigating interference in a cable network system, in accordance with an exemplary embodiment of the invention.

FIG. 6 is a flow chart illustrating exemplary steps for duty cycling a cable modem based on essential messages mapped onto the primary channel, in accordance with an exemplary embodiment of the invention.

### DETAILED DESCRIPTION OF THE INVENTION

Certain embodiments of the invention may be found in a method and system for detecting and mitigating interference in a cable network system. The cable network system may comprise a cable modem termination system (CMTS) device, one or more network nodes, one or more amplifiers and/or one or more cable modem (CM) devices. In various embodiments of the invention, a cable modem device is operable to capture signals over a wide spectrum including one or more cable frequency bands and sub-bands and extract one or more cable channels from the captured signals. Based on the analysis, the cable modem device may be operable to analyze the extracted one or more cable channels and assigns a portion of the extracted one or more cable channels for upstream and/or downstream communication. The cable modem device may be operable to recapture one or more previously unused cable channels to be utilized for the upstream and/or downstream communication based on the analysis. The cable modem device may be operable to determine noise, interference, and/or blocker information corresponding to the extracted one or more cable channels based on the analysis. Based on the determined noise, interference, and/or blocker information, the cable modem termination system device may (1) assign or reassign one or more cable channels to be utilized for the upstream and/or downstream communication and/or (2) block one or more cable channels from being utilized for the upstream and/or downstream communication. The cable modem termination system device may be operable to generate a map that indicates a location of the determined noise, interference, and/or blocker information. One or more cable modem devices in the cable network system and/or one or more amplifiers in the cable network system may be configured by the cable modem termination system device based on the determined noise, interference, blocker information and/or the generated map. The cable modem termination system device may also be operable to map one or more essential messages onto a primary channel of the extracted one or more cable channels to enable one or more cable modem devices to autonomously transition into and out of single channel mode. The one or more essential messages may be mapped onto a primary channel that is utilized for downstream communication and/or a primary channel that is utilized for upstream communication. In some embodiments of the invention, one or more non-essential messages may also be mapped onto the primary channel along with the essential messages. The one or more essential messages that are mapped onto the primary channel may be utilized to control duty cycle operation of one or more of the cable modem devices in the cable network system.

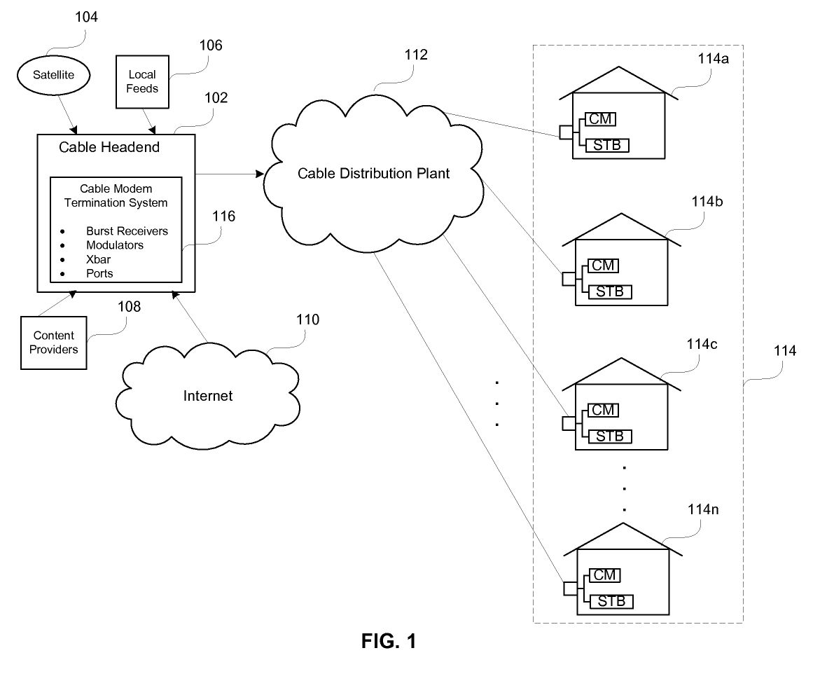

FIG. 1 is a block diagram that illustrates an exemplary cable network system, in accordance with an exemplary embodiment of the invention. Referring to FIG. 1, there is shown a cable headend 102, a cable distribution plant 112 and residences and businesses 114.

The cable headend comprises a cable modem termination system 116, the latter of which comprises a plurality of burst receivers, modulators, a switching element (e.g. a crossbar (XBAR)), and a plurality of ports. The cable headend 102 is shown coupled to a plurality of other systems comprising a satellite system 104, local information feeds 106, the Internet 110, and content providers 108. The cable headend 102 is also shown coupled to a cable distribution plant 112. The satellite system 104, the local information feeds 106, the Internet 110, and the content providers 108 provide content to cable headend 102.

The cable distribution plant 112 comprises suitable devices and media that are operable to transport cable network traffic. Exemplary media may comprise wired, wireless and/or optical media. The cable distribution plant 112 may be operable to transport and/or distribute content from the cable headend 102 to the home and offices 114. The cable distribution plant 112 is operable to transport information and content from the residences and/or businesses 114 to the cable headend 102.

The residences and/or businesses 114a, 114b, 114c, . . . , 114n are shown coupled to the cable distribution plant 112. The residences and/or businesses 114a, 114b, 114c, . . . , 114n may be collectively referenced as 114. Each of the residences and/or businesses 114a, 114b, 114c, . . . , 114n may comprise a cable modem and/or set top box that is operable to communicate with and receive media from the cable headend 102. Information may also be communicated from the residences and/or businesses 114a, 114b, 114c, . . . , 114n.

In accordance with various exemplary embodiments of the invention, in operation, the cable modem termination system 116 is operable to receive information and/or content from each of the residences and/or businesses 114a, 114b, 114c, . . . , 114n via the burst receivers. In this regard, any one of the burst receivers may be coupled, via the crossbar or switching element, to any of the cable modem termination system ports that handles the residences and/or businesses 114a, 114b, 114c, . . . , 114n.

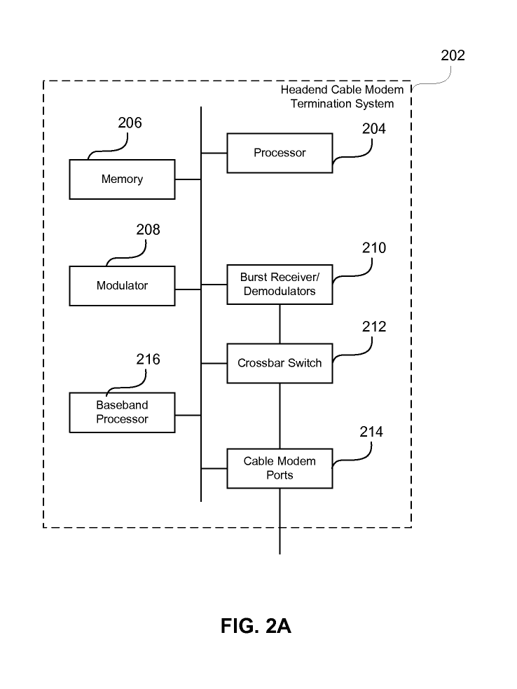

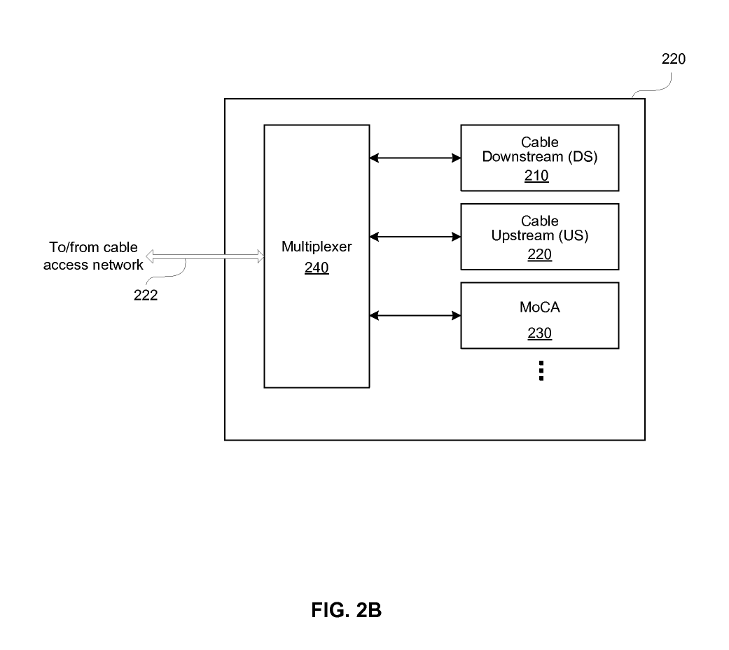

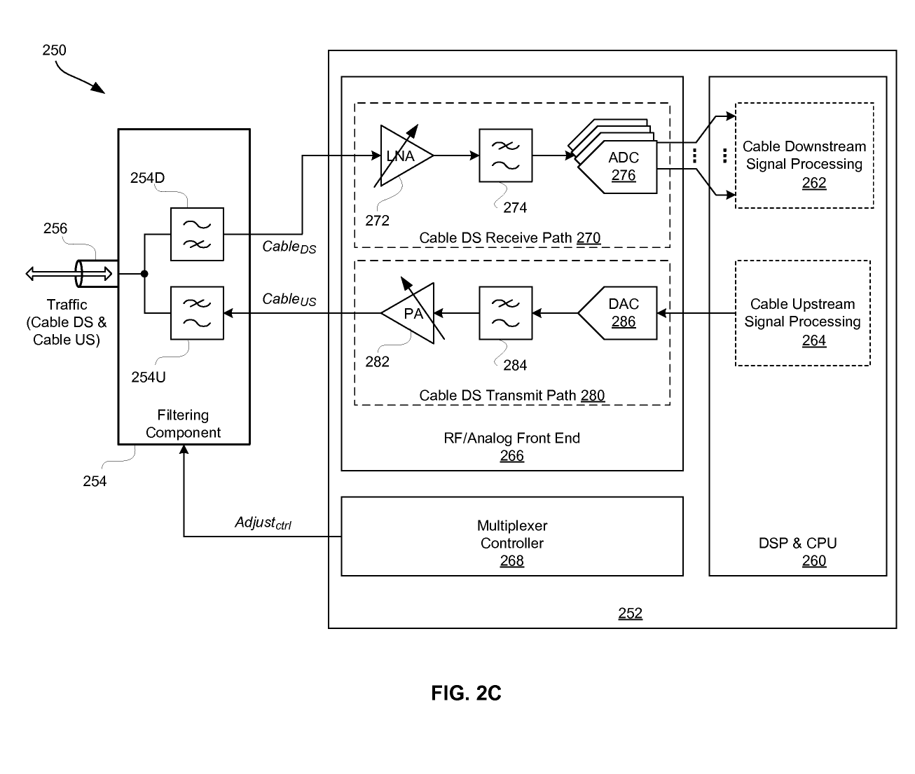

FIG. 2A is a block diagram that illustrates an exemplary cable modem termination system that utilizes a plurality of burst receivers and port switching in the cable headend, in accordance with an embodiment of the invention. Referring to FIG. 2A, there is shown a cable modem termination system 202 in a headend. The cable modem termination system 202 may comprise a processor 204, a memory 206, a plurality of modulators 208, a plurality of burst receivers/demodulators 210, a crossbar switch 212, cable modem termination system ports 214 and a baseband processor 216. Although the processor 204 is shown separate from the baseband processor 216, the invention is not limited in this regard. Accordingly, the functions of the processor 204 and the baseband processor 216 may be combined or integrated and handled by a single processor.

The processor 204 may comprise suitable logic, circuitry and/or interfaces that may be operable to control the communication of signals from the cable headend to the customer premises, which are located downstream. The processor 204 may be operable to configure the cable modem termination system ports 214, the crossbar switch 212, the burst receiver/demodulators 210, the memory 206, the baseband processor 216 and/or the modulators 208.

The memory 206 may comprise suitable logic, circuitry interfaces and/or code that may be operable to store information that may be transmitted by and/or received by the cable headend. The memory 206 may be operable to store information that may be utilized to configure one or more of the cable modem termination system 202, the processor 204, the plurality of modulators 208, the plurality of burst receivers/demodulators 210, the crossbar switch 212, the cable modem termination system ports 214, and/or the baseband processor 216.

Each of the plurality of modulators 208 may comprise suitable logic, circuitry and/or interfaces that may be operable to convert digital signals to RF signals. The resulting RF signals may be communicated from the cable headend 102 to a corresponding one of the cable modems and/or set top boxes located in the residences and/or businesses 114a, 114b, 114c, . . . , 114n.

Each of the plurality of burst receivers/demodulators 210 may comprise suitable logic, circuitry and/or interfaces that may be operable to convert received RF signals that may be communicated from any of the cable modems and/or set top boxes located in the residences and/or businesses 114a, 114b, 114c, . . . , 114n, to digital signals. The burst receivers/demodulators may be also be referred to as cable modem termination system demodulators.

The crossbar switch 212 may comprise suitable logic, circuitry and/or interfaces that may be operable to couple any of the cable modems and/or set top boxes located in the residences and/or businesses 114a, 114b, 114c, . . . , 114n to any of the burst receivers or demodulators located in the cable modem termination system 116. In this regard, the cross-bar may comprise a plurality of switches that may be activated or deactivated to select a desired receive (Rx) path or Rx port that couples one of the plurality of residences and/or businesses 114a, 114b, 114c, . . . , 114n. A processor, such as the processor 204, the baseband processor 216, and/or the burst receivers or demodulators 210 may be operable to configure the switches in the crossbar switch 212.

Each of the cable modem termination system ports 214 may comprise suitable logic, circuitry and/or interfaces that may be coupled to and operable to receive information and/or content from any of the cable modems that are located at the customer premises or the residences and/or businesses 114a, 114b, 114c, . . . , 114n. In accordance with various embodiments of the invention, each of the cable modem termination system ports 214 may be operable to handle a plurality of cable modems located in the customer premises or the residences and/or businesses 114a, 114b, 114c, . . . , 114n.

The baseband processor 216 may be operable to process baseband signals resulting from demodulation by the plurality of burst receivers/demodulators 210. The baseband signals resulting from demodulation by the plurality of burst receivers/demodulators 210 may be stored in the memory 206. The baseband processor 216 and/or the processor 204 may be operable to configure the crossbar switch 212 to couple any one of the cable modem termination system ports 214 to any channel corresponding to one of the plurality of the burst receivers/demodulators, which is selected to handle processing of signals received from any one of the customer premises cable modems. The customer premises cable modems are located in the residences and/or businesses 114a, 114b, 114c, . . . , 114n. In this manner, any one of the cable modem termination system ports 214 is operable to handle traffic from any channel for one of the residences and/or businesses 114a, 114b, 114c, . . . , 114n.

FIG. 2B is a block diagram that illustrates an exemplary multiband communication system that supports multiplexing various communication streams, which may be used in accordance with various implementations of the invention. Referring to FIG. 2B, there is shown a transceiver system 220. The transceiver system 220 may comprise suitable circuitry, interfaces, logic, and/or code for use in transmitting and/or receiving a plurality of streams (e.g., using wireline or wireless RF signals), such as over physical link 222. The physical link 222 may comprise, for example, coaxial or twisted-pair cabling. For example, the transceiver system 220 may be utilized to support communication (transmission and/or reception) of streams to and/or from remote systems (e.g., cable head-ends) and/or local/nearby systems (e.g., with other devices co-located with a device that comprises the transceiver system 220 within a particular physical space, such as a home network or office network). The transceiver system 220 may comprise transceiver circuitry residing, for example, in a set-top-box or similar devices. In this regard, examples of streams that may be supported by the transceiver system 220 may comprise cable (e.g., DOCSIS based) streams, when the transceiver system 220 is communicating with cable head-ends, and/or Multimedia over Coaxial Alliance (MoCA) streams, such as when the transceiver system 220 interacts with other (local) devices or systems. The disclosure, however, is not so limited, and the transceiver system 220 may be utilized in substantially the same manner as described herein with respect to various types of streams. As shown in FIG. 2B by way of example, the transceiver system 220 may comprise a cable television downstream (“cable DS”) processing module 210, a cable upstream (“cable US”) processing module 220, where cable US comprises, for example, a DOCSIS based upstream, a Multimedia over Coaxial Alliance (MoCA) processing module 230, and a multiplexer 240.

The cable DS processing module 210 may comprise suitable circuitry, interfaces, logic, and/or code operable to process cable DS signals. Examples of operations performed by the cable DS processing module 210 comprise demodulation and decoding of cable DS signals.

The cable US processing module 220 may comprise suitable circuitry, interfaces, logic, and/or code operable to process cable US signals. Examples of operations performed by the cable US processing module 220 comprise modulation and encoding of cable US signals.

The MoCA processing module 230 may comprise suitable circuitry, interfaces, logic, and/or code operable to process MoCA signals. Examples of operations performed by the MoCA processing module 230 comprise modulation, demodulation, encoding, and decoding of MoCA signals.

The multiplexer 240 may comprise suitable circuitry, interfaces, logic, and/or code that may be operable to selectively filter signals during communication to/from the transceiver system 220—e.g., passing (or blocking) signals in particular bands in one or both directions (from or into the transceiver system 220). As shown in FIG. 2B, the multiplexer 240 may be configured as, for example a ‘triplexer’, which may be operable to selectively handle filtering of signals corresponding to three different or distinct frequency ranges or bands. In this regard, the multiplexer 240 may be configured to allow/pass through from the transceiver system 220 only signals having frequencies within a first range (e.g., defined as corresponding to the cable US), to allow/pass through into the transceiver system 220 only signals having frequencies within a second range (e.g., defined as corresponding to the cable DS), and to block signals having frequencies within a third range (e.g., defined as that corresponding to MoCA, which while sharing the same coaxial cables used by cable, is limited to local interactions—i.e., within s home or office network). In other instances, the multiplexer 240 may only be used to handle two streams (e.g., only cable US and cable DS), in which case it may be referred as ‘diplexer’. In some instances, the multiplexer 240 may be operable to demultiplex a multiplexed (e.g., frequency multiplexed) signal into its constituent signals. Use of triplexers and diplexers for band separation in multiband communication systems is described in more detail in the United States patent application having Ser. No. 13/301,102, which was filed on Nov. 11, 2011, and which is incorporated herein by reference in its entirety.

In operation, a composite signal comprising a cable US signal, a cable DS signal, and a MoCA signal is present on the physical link 222. A first component of the composite signal may comprise cable US signals, which may utilize a first frequency band on the physical link 222. A second component of the composite signal may comprise cable DS signals, which may utilize a second frequency band on the physical link 222. A third component of the composite signal may comprise MoCA signals, which may utilize a third frequency band on the physical link 222. The multiplexer 240 (which in such scenario would be a triplexer) may filter the composite signal to reduce undesired signal components at each of the MoCA processing module 230, the cable DS processing module 220, and the cable US processing module 210. In various implementations, the transceiver system 220 may be configured to incorporate a dynamically tunable architecture. In this regard, the transceiver system 220 may comprise one or more components which may be used to allow for adjusting or modifying of the frequency bands assigned or allocated to the different streams that may be communicated through the transceiver system 220. Accordingly, the frequency band assigned or allocated to the cable DS signals, cable US signals, and/or the MoCA signals may be modified (even in real-time or on the fly), and the transceiver system 220 may be re-tuned dynamically to account for these changes—e.g., the multiplexer 240 reconfigured to handling received/transmitted composited signals based on the band re-assignments/re-allocations. An example of such implementation is described in U.S. application Ser. No. 13/887,314, entitled “Method and System for Tunable Upstream Bandwidth Utilizing an Integrated Multiplexing Device,” which is hereby incorporated herein by reference in its entirety. The multiplexer 240 is a source of signal attenuation.

In accordance with an embodiment of the invention, the cable modem may utilize a full spectrum capture (FSC) receiver that may be operable to capture the entire frequency band and to detect interference on the communication medium. The full spectrum capture receiver in the cable modem may be operable to utilize, for example, low-complexity diversity using coarse FFT and coarse sub-band-wise combining algorithms to determine information about the entire frequency band and/or sub-bands. This information may be utilized in a variety of ways. In one embodiment of the invention, a full spectrum capture (FSC) enabled cable modem may be operable to utilize the information to determine the location of interference and/or noise, avoid those channels that are affected and/or provide interference cancellation as needed.

Various aspects of full spectrum capture may be found in U.S. application Ser. No. 13/485,003 filed May 31, 2012, U.S. application Ser. No. 13/336,451 filed on Dec. 23, 2011 and U.S. application Ser. No. 13/607,916 filed Sep. 10, 2012, each of which is hereby incorporated herein by reference in its entirety. U.S. application Ser. No. 13/356,265, which was filed on Jan. 23, 2012 discloses operation of an exemplary full spectrum capture receiver and is hereby incorporated herein by reference in its entirety. U.S. Pat. No. 8,010,070, (application Ser. No. 12/247,908), which issued on Aug. 30, 2011, discloses an exemplary “Low-Complexity Diversity Using Coarse FFT and Coarse Sub-band-wise Combining” algorithm, and is hereby incorporated herein by reference in its entirety.

In accordance with various embodiments of the invention, full spectrum capture may also be utilized to diagnose the sources of noise in the cable plant and may attempt to recapture spectrum that would typically be unusable. Typically the low end of the spectrum (e.g., bandwidth below the triplexer split point, which may be the low-end bandwidth of about 20 MHz) is basically unusable. This may occur due to several factors such as, for example, poorly grounded cabling. Each full spectrum enabled cable modem may comprise a switch that bypasses the triplexer (when the cable modem is not transmitting) and capture the entire cable spectrum, including the low-end bandwidth of about 20 MHz. The full spectrum enabled cable modem may be operable to report this information to the headend. Those cable modems that may be the source of the noise or may be closer to the source of the noise will report higher noise levels. In this manner, the headend may be operable to deductively determine where the location of the sources of the noise. Repair personnel may be dispatched to the determined location to inspect and/or replace the cabling, or to do whatever else may be necessary to mitigate the noise. Over time this may enable a cable operator to reclaim some of the low-end bandwidth of about 20 MHz.

The various sources of noise in the cable plant may be determined and resulting information may be utilized to recapture, for example, low-end bandwidth. The full spectrum capture cable modem may comprise a switch that may be utilized to bypass the triplexer in order to sense the medium when the upstream is not transmitting. The full spectrum capture cable modem may then report the noise near or in the vicinity of a particular home or office that is served by the full spectrum capture cable modem. The full spectrum capture cable modem and/or the CMTS may be operable to generate a map of the noise and deductively pinpoint the source or sources of noise within the cable plant. In various embodiments of the invention, the full spectrum capture cable modems may be operable to execute frequency domain and time domain signal analyses and the results may be utilized by the cable modems and/or the cable modem termination system, or sent to a central processor for processing. Interference and/or noise cancellation related information may also be shared amongst the cable modems and the CMTS.

FIG. 2C is a block diagram that illustrates an exemplary cable modem transceiver system comprising a full spectrum capture receiver, in accordance with an exemplary embodiment of the invention. The transceiver system 250 may be substantially similar to the transceiver system 220 of FIG. 2B. In this regard, the transceiver system 250 may comprise suitable circuitry, interfaces, logic, and/or code for use in transmitting and/or receiving a plurality of streams (e.g., using wireline or wireless based RF signals), using a multiplexing based filtering component to control passing (or blocking) of streams corresponding to particular bands. In this regard, in some instances multiple streams may be communicated concurrently (and/or in both direction—i.e., downstream/downlink, that is to the transceiver system 250 and upstream/uplink, that is from the transceiver system 250) over the same physical medium (e.g., link 256). The link 256 may comprise, for example, a coaxial or a twisted-pair cable. The transceiver system 250 may comprise, for example, a transceiver chip 252 and an off-chip filtering component 254.

The transceiver chip 252 may comprise suitable circuitry, interfaces, logic, and/or code for processing streams communicated by the transceiver system 250. In this regard, transceiver chip 252 may be operable to perform such functions as amplification, modulation/demodulation, encoding/decoding, conversions (digital-to-analog and analog-to-digital), and the like. The transceiver chip 252 may comprise, for example, a digital signal processing (DSP)/central processing unit (CPU) 260, a RF/analog front end 266, and a multiplexing controller 268.

The DSP/CPU 260 may comprise suitable circuitry, interfaces, logic, and/or code for performing various processing functions, such as digital signal processing (DSP), other signal processing related functions (e.g., modulator-demodulator (modem) related functions), and/or other processing functions typically associated with a central processing unit (CPU) (e.g., data manipulation, control and management of the transceiver chip 252 and/or its components, etc.). For example, the DSP/CPU 260 may be operable to perform digital signal processing, such as cleaning up signals transmitted or received by the transceiver system 250. In this regard, the DSP/CPU 260 may be operable to perform channel selection and/or filtering, digital scaling, rate conversions, and/or the like. The DSP/CPU 260 may also be operable to perform other, more specialized signal processing related operations. For example, when processing received signals, the DSP/CPU may be operable to perform synchronization, equalization, demapping, and/or channel encoding. The channel decoder may utilize a concatenated code such as an inner code and an outer code. An example of such a concatenated code may comprise a low-density parity-check (LDPC) code followed by a Bose-Chaudhuri-Hocquenghen (BCH) code. When processing signals for transmission, the DSP/CPU may be operable to perform channel encoding and/or equalization, and/or mapping. In some instances, the DSP/CPU 260 may also be configured to support full spectrum capture (e.g., performing necessary MAC layer and/or Link layer operations).

The DSP/CPU 260 may comprise portions (logical and/or physical) that may be specifically configured to support handling of particular streams. For example, when supporting communication of cable streams, the DSP/CPU 260 may comprise a cable downstream (DS) signal processing module 262 and a cable upstream (US) signal processing module 264. In this regard, the cable DS signal processing module 262 may comprise suitable circuitry, interfaces, logic, and/or code operable to perform digital signal processing (and/or other related signal processing functions) of cable DS signals, such as to enable processing of digital baseband signals that are obtained or generated by the RF/analog front end 266 based on received analog signals. The cable US signal processing module 264 may comprise suitable circuitry, interfaces, logic, and/or code operable to perform digital signal processing (and/or other related signal processing functions) of cable US signals, such as generating baseband signals that are suitable for modulation by the RF/analog front end 266.

The RF/analog front end 266 may comprise suitable circuitry, interfaces, logic, and/or code that may be operable to perform RF transmission and/or reception, over a plurality of frequency bands, and/or perform various related analog processing operations, during communications from and/or to the transceiver system 250.

In some instances, the RF/analog front end 266 may comprise dedicated portions (logical and/or physical) that may be specifically configured to support transmission and/or reception of particular RF signals (and/or performing necessary analog processing associated therewith). For example, when supporting communication of cable streams, the RF/analog front end 266 may comprise a cable downstream (DS) receive path 270 and a cable upstream (US) transmit path 280. In this regard, each of the cable DS receive path 270 and the cable US transmit path 280 may comprise suitable circuitry, interfaces, logic, and/or code of the RF/analog front end 266 that are configured to particularly perform RF communication (reception and transmission, respectively) and related analog signal processing of cable DS signals and cable US signals, respectively. For example, the cable DS receive path 270 may comprise one or more variable gain low-noise amplifier (LNAs) 272, one or more filters 274, and one or more analog-to-digital converters (DACs) 276, which may be configured to enable demodulating received downstream signals into corresponding digital baseband signals (for processing by the cable DS signal processing module 264). The cable DS transmit path 280 may comprise one or more digital-to-analog converters (DACs) 282, one or more filters 284, and one or more variable gain power amplifier (PAs) 286, which may be configured to enable modulating digital baseband signals (as received from the cable US signal processing module 264) to corresponding upstream signals.

In an exemplary embodiment of the invention, the cable downstream receive path 270 may comprise a full spectrum capture receiver downstream path. U.S. patent application Ser. No. 13/301,102, which was filed on Nov. 11, 2011, provides more details of an example full spectrum capture receiver and is hereby incorporated herein by reference in its entirety. The full spectrum capture receiver path 270 may be utilized to capture signals over a wide cable spectrum including one or more cable frequency bands and sub-bands and extract one or more cable channels from the captured signals. The captured channels may be analyzed and information resulting from the analysis may be utilized by one or more cable modems to detect and mitigate interference on the medium in the cable network system.

The multiplexing controller 268 may comprise suitable circuitry, interfaces, logic, and/or code for controlling multiplexing of streams communicated to and/or from the transceiver system. For example, the multiplexing controller 268 may control handling of streams in the off-chip filtering component 254, such as controlling passing or blocking of streams (e.g., based on band ranges associated therewith). In this regard, streams in particular band(s) may be reserved for a particular type of communication (e.g., cable) and/or a particular direction (upstream or downstream). In some instances, multiplexing conditions may change or be modified. Accordingly, the multiplexing controller 268 may be operable to adjust the operations of the filtering component 254, such as by generation of control signals, which may be communicated to the filtering component 254 to configure and/or control operation of the filtering component 254. The filtering component 254 may comprise and on-chip or off-chip component.

In the case of a diplexer, the multiplexing controller 268 may comprise a diplexing controller. In the case of a triplexer, the multiplexing controller 268 may comprise a triplexing controller. The signal Adjust_{ctrl} may be utilized to control the upstream and downstream cutoff frequencies for the diplexer/triplexer based on, for example, signals from the system operator (cable headend/CMTS).

The off-chip filtering component 254 may comprise suitable circuitry, interfaces, logic, and/or code for handling routing of streams communicated by the transceiver system 250, such as based on particular bands. For example, the off-chip filtering component 254 may be configured as a multiband filtering module, comprising a plurality of filters that may be operable to filter and/or adjust the corresponding bandwidth of particular signals. Furthermore, the off-chip filtering component 254 may be configured to support use of a single physical medium (e.g., the link 256) to communicate multiple streams concurrently and/or in both directions (e.g., cable US signals and cable DS signals). In this regard, the off-chip filtering component 254 may comprise a plurality of special filters for enabling handling of signals associated with particular streams in the off-chip filtering component 254, such as by adaptively passing/blocking these signals, and/or accounting for effects of communication of signals associated with other streams. For example, the off-chip filtering component 254 may comprise suitable logic, circuitry, interfaces and/or code that may be operable to function as a downstream filter 254D. In this regard, the downstream filter 254D may be operable to filter signals corresponding to cable downstream communications, which (for DOCSIS based communications) may be within approximately the band 85-1003 or 50-1003 MHz. The downstream filter 254D may also be operable to filter out cable US signals, to prevent saturation that may be caused thereby, since both DS signals and US signals are communicated on the same physical medium—that is the link (e.g., coaxial cable) 256.

The off-chip filtering component 254 may also comprise suitable logic, circuitry, interfaces and/or code that may be operable to function as an upstream filter 254U. In this regard, the upstream filter 254U may be configured to filter signals corresponding to cable upstream communication, which may be, for DOCSIS based communications, within approximately the band 5-42 MHz. The upstream filter 254U may also be operable to filter out harmonics and other spurious signals generated or caused by the US signals, since both US signals and DS signals are communicated on the same physical medium—that is the link (e.g., coaxial cable) 256. There may be a separation band between the various bands of frequencies that are handled by the different filter modules in the off-chip filtering component 254 (e.g., the upstream filter 254U and the downstream filter 254D). The filtering component 254 may be referred to as a diplexer since it is operable to handle the cable upstream (signals) and the cable downstream (signals). Notwithstanding, the disclosure is not limited in this regard. Accordingly, in some instances there may be a third stream (signals) handled, such as a MoCA signals, thus the filtering component 254 would be a triplexer since it may be configured to handle three signals: a cable upstream signal, a cable downstream signal and the MoCA signal. While the filtering component 254 has been described as ‘off-chip’, the invention is not necessarily so limited. Accordingly, in some implementations, at least a portion of the filtering component 254 may be incorporated into (and/or functions associated therewith may be performed by) the transceiver chip 252.

In operation, the transceiver system 250 may support communication of composite signals, such as signals comprising cable upstream (US) signals and cable downstream (DS) signals. In this regard, the cable US signals may typically utilize a first (fixed) frequency band (e.g., ˜5-42 MHz in DOCSIS based systems) whereas the cable DS signals may typically utilize a second (fixed) frequency band (e.g., ˜80-1003 MHz in DOCSIS based systems). Accordingly, typical/legacy systems may incorporate a multiplexer (e.g., diplexer) with fixed filtering modules. In other words, the downstream filter 254D and the upstream filter 254U may be simply implemented as fixed filters that operate at the pre-configured frequency bands (for downstream and upstream communications). It some instances, however, it may be desirable to allow for modifications (including dynamic ones) of allocated frequency bands. For example, in some instances it may be desirable to allow for adjusting of the frequency band allocated for cable upstream communications, to accommodate for increases/decreases in user required bandwidth. Such band changes, however, may not be feasible with architectures that are tailored for fixed frequency bands. Accordingly, the transceiver system 250 may be configured to allow for dynamic adjustments in frequency bands used for streams communicated by the system.

In an exemplary embodiment of the invention, the downstream filter 254D and the upstream filter 254U may be configured as tunable/reprogrammable filter modules. In this regard, the downstream filter 254D and the upstream filter 254U may comprise suitable logic, circuitry, interfaces and/or code that may be operable to adjust corresponding bandwidth of upstream and/or downstream signals, respectively. For example, the upstream filter 254U may comprise a tunable or programmable low pass filter (LPF), with a cutoff frequency of F_{cus}. The downstream filter 254D may comprise a tunable or programmable high pass filter (HPF) with a cutoff frequency of F_{cds}. Accordingly, the transceiver system 250 may support and/or allow frequency band adjustments, which may be effectuated by tuning/reprogrammable the downstream filter 254D and the upstream filter 254U (e.g., adjusting their cutoff frequencies, F_{cds} and F_{cus}). The amount by which the cutoff frequencies, F_{cds} and F_{cus}, are adjusted may be determined based on the desired frequency band changes. Furthermore, for added measure of reliability, changes or modifications in (i.e., tuning or reprogramming) the downstream filter 254D and/or the upstream filter 254U may be performed so as to maintain a separation band between the frequencies of signals handled by the programmable upstream filter module and the programmable downstream filter module.

In an exemplary embodiment of the invention, the multiplexer controller 268 may be configured to control the adjusting of the bandwidth of the tunable or programmable filters 254D and/or 254U. In this regard, the multiplexer controller 268 may be operable to determine any required changes to the filters 254D and/or 254U (e.g., based on reconfiguration of applicable frequency bands, which may be received from the operator, such as through the headend/CMTS, via a control channel for example), and may generate, based on that determination, control signal Adjust_{ctrl}, which may be utilized to adjust the bandwidth of the tunable or programmable filters 254D and/or 254U. In this regard, in instances where the tuning/reprogramming of the filter is achieved by adjusting their cutoff frequencies, F_{cds} and F_{cus}, the control signal, Adjust_{ctrl}, may be operable to control the cutoff frequencies (or changes thereof) for the tunable or programmable filters 254D and/or 254U (e.g., specifying new values, or specifying any increases/decreases to the frequencies).

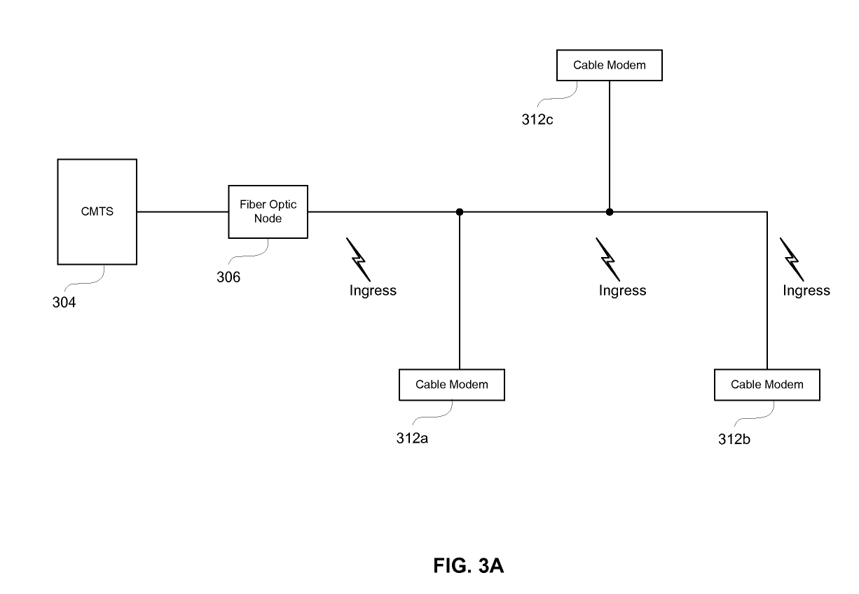

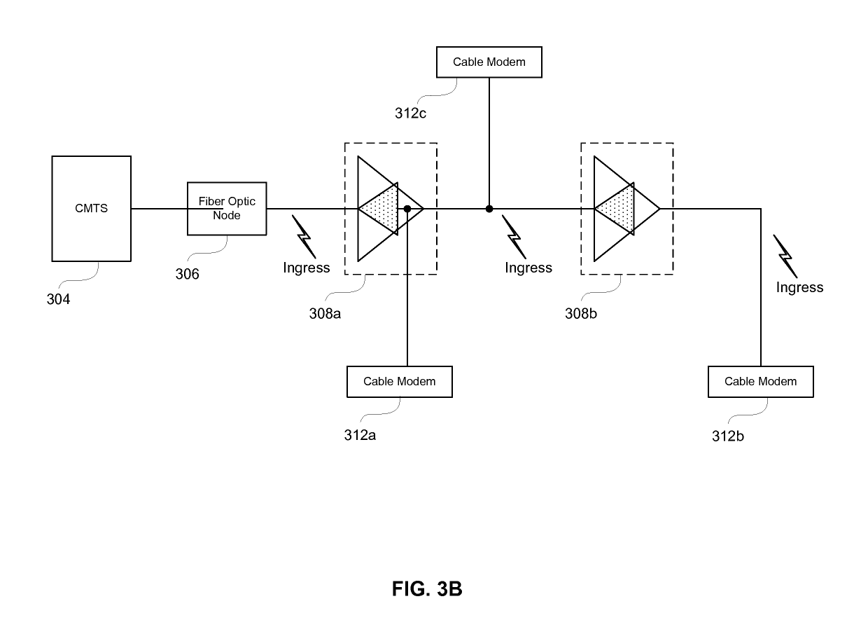

FIG. 3A is a high level block diagram illustrating cable modem assisted monitoring, in accordance with an exemplary embodiment of the invention. Referring to FIG. 3A, there is shown a cable modem termination system (CMTS) 304, a fiber optic node 306 and a plurality of cable modems 312a, 312b, 312c. The cable modems may be collectively referenced as cable modems 312. Ingress refers to the extraneous interference that may be coupled into the cable access and distribution infrastructure. This extraneous interference may generally result in undesired signal disruption.

The cable modem termination system (CMTS) 304 may be substantially similar to the cable modem termination system 116, which is shown in and described with respect to, for example, FIG. 1.

The fiber optic node 306 may comprise suitable logic, circuitry, interfaces and/or code that may be operable to provide regeneration of upstream signals and downstream signals in the cable plant.

Each of the plurality of cable modems 312a, 312b, 312c may comprise suitable logic, circuitry, interfaces and/or code that may be operable to provide modulation and demodulation of signals that are communicated between the CMTS and the customer premises (e.g. homes and offices) where the cable modems are located. Each of the plurality of cable modems 312a, 312b, 312c may be operable to provide broadband services to their corresponding customer premises. One or more of the plurality of cable modems 312a, 312b, 312c may be operable to provide cable modem assisted monitoring of upstream spectrum. In this regard one or more of the plurality of cable modems 312a, 312b, 312c may comprises suitable logic, circuitry, interface and/or code that may be operable to receive signals in the upstream band while it is not transmitting. This portion of the cable modem circuitry may be coupled into the upstream port of the triplexer in order to provide monitoring on the upstream medium. After receiving the signal, an FFT may be performed for analysis of spectral components. This portion of the cable modem circuitry may be shut off or isolated during active transmission of this modem or nearby modems whose transmit signals may saturate this portion of the cable modem circuitry. In this regard, this portion of the cable modem circuitry may comprise a high impedance path.

One or more of the plurality of cable modems 312a, 312b, 312c may comprise, for example, a full spectrum capture receiver that may be operable to monitor the communication medium in the downstream direction. The information resulting from the monitoring may be processed by the monitoring cable modem and/or may be communicated to one or more other modems for processing. In some embodiments of the invention, the information resulting from the monitoring may be communicated to the CMTS 304 for processing. In this regard, the CMTS 304 may be operable to process the information and determine changes that are to be made in order to mitigate the effects of interference that are experienced by one or more of the plurality of cable modems 312a, 312b, 312c. For example, the CMTS 304 may determine that the modulation profile should be changed. Accordingly, the CMTS 304 may notify one or more of the plurality of cable modems 312a, 312b, 312c to change to a specified modulation profile.

In operation, one or more of the plurality of cable modems 312a, 312b, 312c may be operable to monitor spectrum in the upstream direction while they are not actively transmitting in the upstream direction. One or more of the plurality of cable modems 312a, 312b, 312c may be operable to report results for the spectrum to the CMTS 304 as part of, for example, the network management protocol, which specifies the upstream spectrum as one of the management information database (MIB) objects. Other monitoring and/or management protocols may be utilized without departing from the spirit and/or scope of the various exemplary embodiment of the invention.

The CMTS 304 may be operable to analyze the monitored information that may be received from one or more of the plurality of cable modems 312a, 312b, 312c and may be able to identify which of the one or more of the plurality of cable modems 312a, 312b, 312c may be subjected to or exposed to ingress. Exemplary analysis may comprise time domain and frequency domain analysis. The cable modems 312a, 312b, 312c and/or the CMTS 304 may be operable to utilize deductive reasoning to pinpoint the location of ingress. In accordance with an embodiment of the invention, the CMTS 304 may be operable to generate and/or maintain a map of ingress intensity at various locations corresponding to one or more of the plurality of cable modems 312a, 312b, 312c. The maps may be dynamically updated and may be utilized to eliminate certain locations as possible ingress locations. The locations of the cable modems reporting the highest ingress power may be utilized to narrow down the likely location of ingress coupling into the cable plant.

FIG. 3B is a high level block diagram illustrating amplifier assisted monitoring, in accordance with an exemplary embodiment of the invention. Referring to FIG. 3A, there is shown a cable modem termination system (CMTS) 304, a fiber optic node 306, bidirectional amplifiers 308a, 308b and a plurality of cable modems 312a, 312b, 312c. The cable modems may be collectively referenced as cable modems 312. Ingress refers to the extraneous interference that may be coupled into the cable access and distribution infrastructure. This extraneous interference generally results in undesired signal disruption.

The cable modem termination system (CMTS) 304 may be substantially similar to the cable modem termination system 116, which is shown in and described with respect to, for example, FIG. 1. In accordance with an embodiment of the invention, the CMTS 304 may be operable to control a programmable gain of the bidirectional amplifiers 308a, 308b. In accordance with an embodiment of the invention, the CMTS 304 may be operable to monitor the spectrum in order to identify and measure ingress interference in the upstream frequency band of about 5-42 MHz. When an interferer is observed, the CMTS 304 may be operable to program the gain in one or both of the bidirectional amplifiers 308a, 308b in order to decrease the gain by a particular value, for example, 1 dB, for instance. If the interference power is unchanged, this may imply that the interferer is not boosted by the programmed bidirectional amplifier. Otherwise, the CMTS 304 may be operable to observe the interference power change by the corresponding value.

The fiber optic node 306 may comprise suitable logic, circuitry, interfaces and/or code that may be operable to provide regeneration of upstream signals and downstream signals in the cable plant and may be substantially similar to the corresponding component which is illustrated and described with respect to, for example, FIG. 3A.

Each of the plurality of cable modems 312a, 312b, 312c may comprise suitable logic, circuitry, interfaces and/or code that may be operable to provide modulation and demodulation of signals that are communicated between the CMTS and the customer premises (e.g. homes and offices) where the cable modems are located. Each of the plurality of cable modems 312a, 312b, 312c may be operable to provide broadband services to their corresponding customer premises. Each of the plurality of cable modems 312a, 312b, 312c may be substantially similar to the corresponding component which is illustrated and described with respect to, for example, FIG. 3A.

Each of the bidirectional amplifiers 308a, 308b may comprise suitable logic, circuitry, interfaces and/or code that may be operable to provide amplification of upstream and downstream signals. In an exemplary embodiment of the invention, each of the bidirectional amplifiers 308a, 308b may be operable to the amplify signals in the frequency range of about 5-42 MHz in upstream direction (towards node) and amplify signals in the frequency range of 54-1000 MHz in downstream direction. The gain of each of the bidirectional amplifiers 308a, 308b may be programmable and may be controlled by the CMTS 304. The gain of each of the bidirectional amplifiers 308a, 308b may be controlled or programmed through in-band or out-of-band (OOB) signaling. In-band signaling may comprise detecting, for example, received signal strength indicators (RSSIs) and enabling the bidirectional amplifiers 308a, 308b if the RSSI beyond a certain level or threshold. Out-of-band signaling may comprise utilizing, for example, a short pulse at a frequency below 5 MHz to enable the bidirectional amplifiers 308a, 308b. The bidirectional amplifiers 308a, 308b may be operable to logically OR signals from various ports and propagate the signaling further upstream. The signaling may originate from one or more of the plurality cable modems 312a, 312b, 312c.

In an exemplary embodiment of the invention, that CMTS 304 may be operable to map essential messages a primary channel for upstream and/or downstream communication. The essential messages may comprise control information. For example, the essential messages may comprise DOCSIS upstream channel descriptors (UCD), medium access plan (MAP) messages, and station maintenance messages. These allow the plurality of cable modems 312a, 312b, 312c to maintain synchronization with the CMTS 304 in instances when the cable modems 312a, 312b, 312c are not currently providing a high rate of data communication of traffic. The upstream channel descriptors are utilized to control various communication parameters that enable scheduling of communication for the plurality of cable modems 312a, 312b. For example, the upstream channel descriptors may comprise modulation type or modulation profile information. Since downstream communication may be unscheduled, the plurality of cable modems 312a, 312b, 312c generally have to stay awake and listen for messages. The essential messages in the primary channel may be utilized to schedule communication on the downstream and this enables the plurality of cable modems 312a, 312b, 312c to operate in a duty cycle mode. Exemplary station maintenance messages may comprise, for example, key exchanges, which enable encryption of the communication links. Station maintenance messages may also comprise messages that may be utilized to control latency on the communication link.

The mapping of essential messages to the primary channel enables the cable modems 312a, 312b, 312c transition into and out of the single channel mode autonomously. Additionally, since there is no handshaking, the mapping of essential messages onto the primary channel has less impact on network traffic (e.g., latency) as one or more of the cable modems 312a, 312b, 312c may enter or exit the single channel low power mode. The mapping of essential messages also provides less complexity since the CMTS 304 does not have to keep track of the state of all the cable modems.

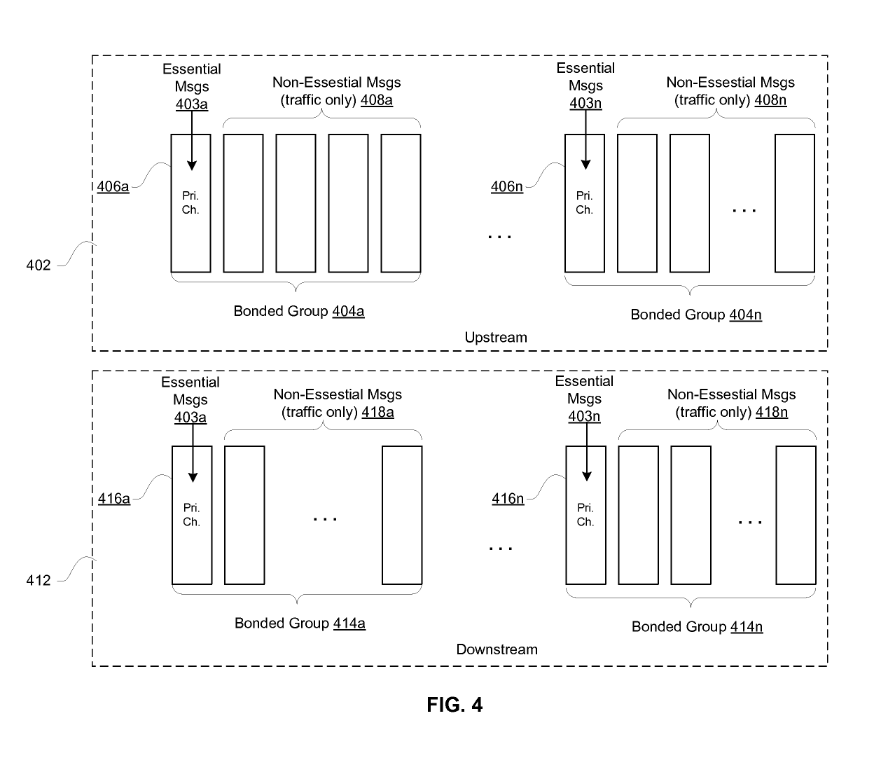

FIG. 4 is a diagram that illustrates the mapping of essential messages onto the primary channel, in accordance with an exemplary embodiment of the invention. Referring to FIG. 4, there is shown an exemplary upstream arrangement 402 for mapping essential messages and an exemplary downstream arrangement 412 for mapping essential messages.

In the exemplary upstream arrangement 402, there is shown bonded groups 404a, . . . , 404n. The bonded group 404a may comprise a primary channel 406a and a plurality of secondary channels 408a. The essential messages may be mapped onto the primary channel 406a. The non-essential messages may be mapped onto the secondary channels 408a, which may be the bearer of the traffic. The bonded group 404n may comprise a primary channel 406n and a plurality of secondary channels 408n. The essential messages may be mapped onto the primary channel 406n. The non-essential messages may be mapped onto the secondary channels 408n, which may be the bearer of the traffic. The number of channels that may be in the bonded groups 404a, . . . , 404n may vary. For example, the bonded groups 404a, . . . , 404n may comprise 4, 8, 16, 32, 64, or a greater number of channels.

In the exemplary downstream arrangement 412, there is shown bonded groups 414a, . . . , 414n. The bonded group 414a may comprise a primary channel 416a and a plurality of secondary channels 418a. The essential messages may be mapped onto the primary channel 416a. The non-essential messages may be mapped onto the secondary channels 418a, which may be the bearer of the traffic. The bonded group 414n may comprise a primary channel 416n and a plurality of secondary channels 418n. The essential messages may be mapped onto the primary channel 416n. The non-essential messages may be mapped onto the secondary channels 418n, which may be the bearer of the traffic. The number of channels that may be in the bonded groups 414a, . . . , 414n may vary. For example, the bonded groups 414a, . . . , 414n may comprise 4, 8, 16, 32, 64, or a greater number of channels.

Although a specific mapping may be necessary in the downstream direction, the mapping in the upstream direction may be optional. There may be various options for the upstream bandwidth allocations. For example, one option may comprise the mapping of only essential messages to primary channels. This has the advantage that the CMTS 304 may remain agnostic to the state of the cable modems 312a, 312b, 312c, at the cost of some complexity in upstream bandwidth allocation. In another example, another option may comprise mapping or allocating bandwidth for both essential and non-essential messages onto primary channels.

One or more of the cable modems 312a, 312b, 312c may be operable to operate in a duty cycle or time slicing mode of operation in order to save power. In this regard, the CMTS 304 may be operable to buffer the essential messages and bursts them at predetermined times, such that the cable modems 312a, 312b, 312c may shut down the primary subcarriers between times when essential messages are to be received. In other words, the cable modems 312a, 312b, 312c may duty cycle on at times when essential messages are to be received, and duty cycle off at times between bursts. The period between bursts may be short enough so that clock drift does not cause the cable modems 312a, 312b, 312c to lose synchronization.

The CMTS 304 may be operable to control monitoring of the cable spectrum in the upstream band. In this regard, one or more FFT/iFFT processing circuits and/or one or more of the plurality of cable modems 312a, 312b, 312c in the CMTS 304 may be utilized to analyze spectral components and detect presence of strong narrowband ingress. The analysis may be done in the frequency and time domain. This information may be utilized by the CMTS to allocate carriers on upstream frequencies for one or more of the plurality of cable modems 312a, 312b, 312c. There are a plurality of different types of upstream burst transmission systems for which the transmissions may be tailored to minimize the impact of narrowband ingress interference. These may comprise, but are not limited to, time division multiple access (TDMA), orthogonal frequency division multiplexing (OFDM), and synchronous code division multiple access (S-CDMA)

For TDMA, the upstream carrier frequencies may be selected such that very strong narrowband ingress frequencies are avoided altogether. Additionally, the half symbol offset location of a narrowband interferer may make a receiver that utilizes band-edge timing recovery algorithms particularly vulnerable to detection errors. Accordingly, this may be avoided for ingress of even lower intensity.

For OFDM, a plurality of sub-carriers may be allocated the same or different modulation schemes to make the best use of the channel. In the presence of narrowband ingress, sub-carriers that may be located at frequencies close to very strong ingress may not be allocated to handling traffic. However, sub-carriers that may be located at frequencies close to weaker ingress may be assigned more robust modulation schemes that carry less information. Sub-carriers that may be located at frequencies unaffected by ingress may be assigned higher modulation modes with high throughput and efficiency.

For S-CDMA, upstream channels located around ingress interferers are assigned a sub-set of spreading codes that may be more immune to ingress at the given frequency. Channels with no ingress interference may be allocated a broader sub-set of spreading codes.

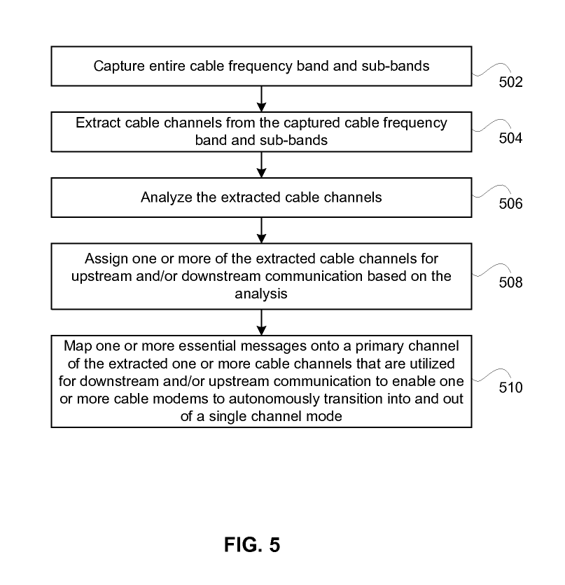

FIG. 5 is a flow chart illustrating exemplary steps for detecting and mitigating interference in a cable network system, in accordance with an exemplary embodiment of the invention. Referring to FIG. 5, there are shown exemplary steps 502 through 510. In step 502, the entire cable frequency band and sub-bands may be captured. In step 504, cable channels may be extracted from the captured cable frequency band and sub-bands. In step 506, the extracted cable channels may be analyzed. The analysis may comprise, for example, frequency domain and/or time domain analysis. In step 508, one or more of the extracted cable channels may be assigned for upstream and/or downstream communication based on the analysis. In step 510, one or more essential messages may be onto a primary channel of the extracted one or more cable channels that are utilized for downstream and/or upstream communication to enable one or more cable modems to autonomously transition into and out of a single channel mode.

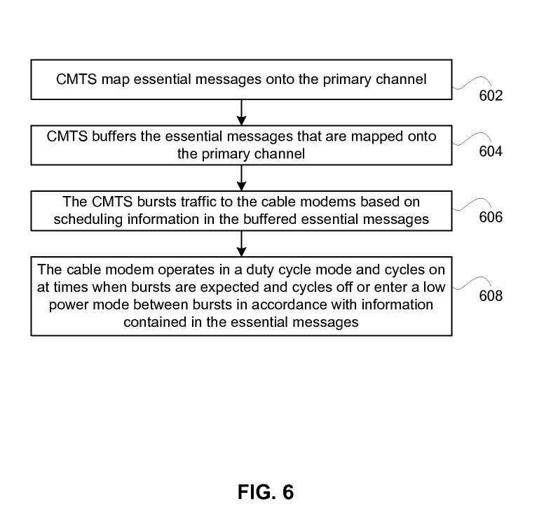

FIG. 6 is a flow chart illustrating exemplary steps for duty cycling a cable modem based on essential messages mapped onto the primary channel, in accordance with an exemplary embodiment of the invention. Referring to FIG. 6, there is shown exemplary steps 602 through 608. In step 602, a cable modem termination system is operable to map essential messages onto the primary channel. In step 604, the CMTS may buffer the essential messages that are mapped onto the primary channel. In step 606, the CMTS bursts traffic to the cable modems based on scheduling information in the buffered essential messages. In step 608, the cable modem operate in a duty cycle mode and cycles on at times when bursts are expected and cycles off or enter a low power mode between bursts in accordance with information contained in the essential messages.

In accordance with various exemplary embodiments of the invention, a cable modem device such as one of the cable modems 312a, 312b, 312c may be operable to capture signals over a wide spectrum including one or more cable frequency bands and sub-bands, for example, the full spectrum capture receive path 270 (FIG. 2C), and extract one or more cable channels from the captured signals. The cable modem device may be operable to analyze the extracted one or more cable channels and assign a portion of the extracted one or more cable channels for upstream and/or downstream communication based on the analysis. Based on the analysis, the cable modem devices may be operable to recapture one or more previously unused cable channels to be utilized for the upstream and/or downstream communication.

The CMTS 304 may also be operable to determine noise, interference, and/or blocker information corresponding to the extracted one or more cable channels based on the analysis. Based on the determined noise, interference, and/or blocker information, the CMTS 304 may (1) assign or reassign one or more cable channels to be utilized for the upstream and/or downstream communication and/or (2) block one or more cable channels from being utilized for the upstream and/or downstream communication. The CMTS 304 may generate a map that indicates a location of the determined noise, interference, and/or blocker information. The generated map may be shared among the one or more cable modems 312a, 312b, 312c by the CMTS 304.

One or more cable modems such as the cable modems 312a, 312b, 312c, which are located at various customer premises in the cable network system, and/or one or more amplifiers such as the bidirectional amplifiers 308a, 308b, which are located in the cable network system, may be configured by the CMTS 304 based on the determined noise, interference, blocker information and/or the generated map. The CMTS 304 may also be operable to map one or more essential messages onto a primary channel of the extracted one or more cable channels to enable one or more cable modems 312a, 312b, 312c to autonomously transition into and out of single channel mode. The one or more essential messages may be mapped onto a primary channel that is utilized for downstream communication and/or a primary channel that is utilized for upstream communication. In some embodiments of the invention, one or more non-essential messages may also be mapped onto the primary channel along with the essential messages. The one or more essential messages that are mapped onto the primary channel may be utilized to control duty cycle operation of one or more of the cable modems 312a, 312b, 312c, which are located at the customer premises in the cable network system.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Throughout this disclosure, the use of the terms dynamically and/or adaptively with respect to an operation means that, for example, parameters for, configurations for and/or execution of the operation may be configured or reconfigured during run-time (e.g., in, or near, real-time) based on newly received or updated information or data. For example, an operation within a transmitter and/or a receiver may be configured or reconfigured based on, for example, current, recently received and/or updated signals, information and/or data.

Other embodiments of the invention may provide a computer readable device and/or a non-transitory computer readable medium, and/or a machine readable device and/or a non-transitory machine readable medium, having stored thereon, a machine code and/or a computer program having at least one code section executable by a machine and/or a computer, thereby causing the machine and/or computer to perform the steps as described herein for detecting and mitigating interference in a cable network system.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
in a cable modem device that is communicatively coupled to a cable modem termination system device in a cable network system:
capturing signals over a wide spectrum comprising one or more cable frequency bands and sub-bands;
extracting one or more cable channels from said captured signals;
analyzing said extracted one or more cable channels; and
assigning a portion of said extracted one or more cable channels for upstream and/or downstream communication based on said analysis.

2. The method according to claim 1, comprising recapturing one or more previously unused cable channels to be utilized for said upstream and/or downstream communication based on said analysis.

3. The method according to claim 1, comprising determining noise, interference, and/or blocker information corresponding to said extracted one or more cable channels based on said analysis.

4. The method according to claim 3, comprising assigning one or more cable channels to be utilized for said upstream and/or downstream communication based on said determined noise, interference, and/or blocker information.

5. The method according to claim 3, comprising blocking one or more cable channels from being utilized for said upstream and/or downstream communication based on said determined noise, interference, and/or blocker information.

6. The method according to claim 3, wherein said cable modem termination system device is operable to generate a map that indicates a location of said determined noise, interference, and/or blocker information.

7. The method according to claim 6, wherein said cable modem termination system device is operable to configure said cable modem device, one or more other cable modem devices in said cable network system and/or one or more amplifiers in said cable network system based on said determined noise, interference, blocker information and/or said generated map.

8. The method according to claim 1, wherein said cable modem termination system device is operable to map one or more essential messages onto a primary channel of said extracted one or more cable channels to enable one or more cable modems to autonomously transition into and out of single channel mode.

9. The method according to claim 8, wherein said one or more essential messages are mapped onto a primary channel that is utilized for downstream communication and/or a primary channel that is utilized for upstream communication.

10. The method according to claim 8, wherein said one or more essential messages that are mapped onto said primary channel are utilized to control duty cycle operation of said cable modem device and/or one or more other cable modem devices in said cable network system.

11. A system, comprising:
a cable modem device that is communicatively coupled to a cable modem termination system device in a cable network system, said cable modem device being operable to:
capture signals over a wide spectrum comprising one or more cable frequency bands and sub-bands;
extract one or more cable channels from said captured signals;
analyze said extracted one or more cable channels; and
assign a portion of said extracted one or more cable channels for upstream and/or downstream communication based on said analysis.

12. The system according to claim 11, wherein said cable modem device is operable to recapture one or more previously unused cable channels to be utilized for said upstream and/or downstream communication based on said analysis.

13. The system according to claim 11, wherein said cable modem device is operable to determine noise, interference, and/or blocker information corresponding to said extracted one or more cable channels based on said analysis.

14. The system according to claim 13, wherein said cable modem device is operable to assign one or more cable channels to be utilized for said upstream and/or downstream communication based on said determined noise, interference, and/or blocker information.

15. The system according to claim 13, wherein said cable modem device is operable to block one or more cable channels from being utilized for said upstream and/or downstream communication based on said determined noise, interference, and/or blocker information.

16. The system according to claim 13, wherein said cable modem termination system device is operable to generate a map that indicates a location of said determined noise, interference, and/or blocker information.

17. The system according to claim 16, wherein said cable modem termination system device is operable to configure said cable modem device, one or more other cable modem devices in said cable network system and/or one or more amplifiers in said cable network system based on said determined noise, interference, blocker information and/or said generated map.

18. The system according to claim 11, wherein said cable modem termination system device is operable to map one or more essential messages onto a primary channel of said extracted one or more cable channels to enable one or more customer premises cable modems to autonomously transition into and out of single channel mode.

19. The system according to claim 18, wherein said one or more essential messages are mapped onto a primary channel that is utilized for downstream communication and/or a primary channel that is utilized for upstream communication.

20. The system according to claim 18, wherein said one or more essential messages that are mapped onto said primary channel are utilized to control duty cycle operation of said cable modem device and/or one or more other cable modem devices in said cable network system.
